(19) United States
(12) Patent Application Publication
(10) Pub. No.: US 2015/0255846 A1
(43) Pub. Date: Sep. 10, 2015

(54) Magnetostatic Surface Wave Nonreciprocal Tunable Bandpass Filters

(71) Applicant: NORTHEASTERN UNIVERSITY, Boston, MA (US)

(72) Inventors: Nian-Xiang Sun, Winchester, MA (US); Jing Wu, Boston, MA (US); Xi Yang, Watertown, MA (US)

(21) Appl. No.: 14/430,659

(22) PCT Filed: Sep. 27, 2013
(86) PCT No.: PCT/US13/62438

§ 371 Date: Mar. 24, 2015

Related U.S. Application Data
(60) Provisional application No. 61/706,190, filed on Sep. 27, 2012.

(51) Int. Cl. H01P 1/215

(52) U.S. Cl. CPC H01P 1/215

(57) ABSTRACT

A nonreciprocal tunable bandpass filter includes a transducer comprising parallel coupled conductive lines; and a ferrite body having at least two opposing parallel edges, the ferrite body disposed over the microstrip transducer such that the parallel edges of the ferrite layer are tilted at a non-zero angle Θ with respect to the parallel coupled microstrip lines of the microstrip transducer.

### RELATED APPLICATIONS

This application claims the benefit of priority under 35 U.S.C. §119(e) to copending U.S. Patent Application Ser. No. 61/706,190, filed Sep. 27, 2012, which is incorporated by reference herein in its entirety.

### INCORPORATION BY REFERENCE

All references, including publications, patent applications and patents cited herein are hereby incorporated by reference in their entireties to the extent allowable to the same extent as if each reference was individually and specifically indicate to be incorporated by reference and was set forth in its entirety.

### BACKGROUND

Modem ultra wideband communication systems and radars, and metrology systems all need configurable subsystems such as tunable bandpass filters that are compact, lightweight, and power efficient. At the same time, isolators with a large bandwidth are widely used in communication systems for enhancing the isolation between the sensitive receiver and power transmitter. If a new class of non-reciprocal RF devices that combines the performance of a tunable bandpass filter and an ultra-wideband isolator is made available, new RF system designs can be enabled which lead to compact and low-cost reconfigurable RF communication systems with significantly enhanced isolation between the transmitter and receiver.

Another issue for magnetostatic surface wave (MSSW)-based YIG resonator devices is the unwanted reflected waves from the straight edges of the YIG slab, which will induce spurious resonance due to the standing wave modes, formed from the forward and backward wave. Several kinds of techniques have been reported to suppress the unwanted reflection by depositing a resistive absorbing film or attaching an additional ferrite material on to the edges of the YIG films to absorb the MSW, or using tapered YIG slab edges at an angle (≠90°), or local low bias field at the edge of the film. These approaches, however, need extra effort to implement.

Conventionally, YIG MSW filters based on single resonance modes have a relatively low power handling, typically below 0 dBm, due to the narrow spin wave linewidth of a single resonance mode. Increasing the power handling capability has been an open challenge for such YIG devices.

### SUMMARY

A new type of non-reciprocal C-band magnetic tunable bandpass filter with ultra-wideband isolation is presented. The bandpass filter was designed with a 45°-rotated yttrium iron garnet (YIG) slab loaded on an inverted-L shaped microstrip transducer pair. This filter shows an insertion loss of 1.6-2.3 dB and an ultra-wideband isolation of more than 20 dB, which was attributed to the magnetostatic surface wave. The non-reciprocal C-band magnetic tunable bandpass filter with ultra-wideband isolation with dual functionality of a tunable bandpass filter and an ultra-wideband isolator will have many applications in RF frontend and other microwave circuits.

In one aspect, a nonreciprocal tunable bandpass filter includes a transducer comprising parallel coupled conductive lines; and a ferrite body having at least two opposing parallel edges, the ferrite body disposed over the microstrip transducer such that the parallel edges of the ferrite layer are tilted at a non-zero angle θ with respect to the parallel coupled microstrip lines of the microstrip transducer.

In one or more embodiments, the transducer comprises microstrip lines.

In any of the preceding embodiments, the microstrip transducer comprises an inverted-L shaped microstrip transducer pair.

In any of the preceding embodiments, the angle θ is in the range of 15°-75°, or. the angle θ is in the range of 30°-60°, or. the angle θ is in the range of 40°-50°.

In any of the preceding embodiments, the ferrite material comprises a ferrite material with ferromagnetic resonance linewidth of <200˜300 Oe at X-band.

In any of the preceding embodiments, the ferrite material is selected from yttrium iron garnet (YIG), spinel ferrites such as Ni-ferrite, NiZn-ferrites, MnZn-ferrites, Li-ferrite, hexaferrites.

In any of the preceding embodiments, the ferrite body comprises yttrium iron garnet (YIG).

In any of the preceding embodiments, the ferrite body has shape selected from the group consisting of square, rectangular, hexagonal, octagonal, trapezoidal and parallelapedal.

In any of the preceding embodiments, the bandpass filter has an isolation of greater than 10 dB.

In any of the preceding embodiments, the bandpass filter has an isolation of greater than 15 dB.

In any of the preceding embodiments, the bandpass filter acts as a ultra-wideband isolator with more than 20-dB isolation at the passband with insertion loss of 1.6-3 dB.

In any of the preceding embodiments, wherein the bandpass filter further includes an electric current source disposed proximate to the ferrite body.

In another aspect a microwave circuit include the nonreciprocal tunable bandpass filter of any of the preceding embodiments.

In another aspect, a method of filtering a signal includes providing a bandpass filter according to of the preceding embodiments; applying a signal as an input signal to the tunable bandpass filter; and controlling a bandwidth of the signal as a function of an applied magnetic field.

In another aspect, a method of producing a signal includes providing a bandpass filter according to any preceding embodiment; applying a signal as an input signal to the tunable bandpass filter; and subjecting the bandpass filter to an external electric field to permit the signal to propagate in only one direction.

The non-reciprocal propagation performance of magnetostatic surface waves in microwave ferrites such as yttrium iron garnet (YIG) provides the possibility of realizing such a non-reciprocal device. Planar ferrite structures with straight edges have been applied in filters utilizing magnetostatic wave theory (MSW). A bandpass filter using two microstrip line antennas was prepared by exciting the magnetostatic surface waves (MSSW) which can be tuned by electric field.

A new method of suppressing the spurious resonance is proposed. The YIG slab is rotated by a proper angle to diminish standing wave modes in order to get a much smoother pass band, and achieve a tunable nonreciprocal bandpass behavior. The designed C-band tunable bandpass filters show a central frequency shift from 5.2 GHz to 7.5 GHz under in-plane magnetic fields from 1.1 kOe to 1.9 kOe with an insertion loss<3 dB. The oblique angle between the DC bias field and the propagation direction leads to non-reciprocal transmission characteristics of the forward and backward MSSW, which provide more than 20 dB isolation across all measured frequency ranges.

Advantages of the system according to one or more embodiments include:
Effectively demonstrates a dual functionality of a tunable band pass filter and an ultra-wideband isolator
Enables an enhanced isolation between the transmitters and receivers as compared to conventional systems
Exhibits a lower insertion loss (1.6˜2.3 dB) and a higher ultra-wideband isolation (more than 20 dB)
Is highly compact, cost effective, and reconfigurable as compared to conventional systems
Simpler and easier fabrication process
Exhibits a wider tunability (5-8 GHz) and a higher power handling (>30 dBm) capability
Commercially useful for many applications such as in RF front end and other microwave circuits

### BRIEF DESCRIPTION OF THE DRAWING

The invention is described with reference to the following figures, which are presented for the purpose of illustration only and are not intended to be limiting. In the Drawings:

FIG. 1 is a schematic illustration of a reciprocal tunable bandgap filter according to the prior art.

FIG. 2 is a schematic illustration of a nonreciprocal tunable bandgap filter having wideband isolation according to one or more embodiments.

FIG. 3 is a schematic of magnetostatic wave (MSW) propagation in an exemplary ferrite slab with a 45° edge according to one or more embodiments, all the directions in this figure are in-plane.

FIG. 4 is a plot of calculated radiation resistances and transduction loss to the top and bottom surfaces of the YIG slab under a bias field of 1.6 kOe.

FIG. 5 is a plot of group delay of the nonreciprocal filter with rotated aligned YIG, thicknesses d=108 μm, under bias magnetic field of 1.6 kOe.

FIG. 6 is a plot of the dispersion relation of the MSSW propagation in a YIG slab with thicknesses d=108 and 500 μm, under bias magnetic field from 1.1 to 1.9 kOe.

FIG. 7 illustrates filter performance with the rotated YIG slab showing (a) S₁₂ with YIG thickness d=500 μm; and (b) Comparison of 3-dB bandwidths between two thicknesses.

FIG. 8 is a plot of Insertion Loss (dB) vs. Frequency (GHz) for a bandpass filter according to one embodiment.

FIG. 9 is a plot illustrating the dispersion relation of MSSW and MSBVW in infinite YIG slab, with dc bias magnetic field 1.6 kOe, where the thickness of the slab is d=108 μm.

FIG. 10 is a plot illustrating the dispersion relation of MSSW in a finite YIG slab placed parallel to bias magnetic field in which the thickness of transducer substrate is t=381 μm; the thickness of YIG slab is d=108 μm, and H_{de}=1.6 kOe, n denotes the standing-wave modes, and m is related to the finite length.

FIG. 11 shows simulated and measured result of bandpass filters with YIG resonator aligned parallel to the transducer, dc magnetic bias field is 1.6 k Oe, applied perpendicular to the feed line: (a) simulated and (b) measured.

FIG. 12 shows simulated and measured results of bandpass filters with a YIG resonator aligned 45 against the transducer.

FIG. 13 illustrates the transmitted power of the proposed bandpass filter in terms of input power, with various of bias magnetic field from 1.1 to 1.9 kOe. The output power is normalized with the input power, and the insertion loss of DUT at 0 dBm. The bandpass filters with two YIG thicknesses are measured: (a) d=108 μm and (b) d=500 μm.

FIG. 14 is a schematic illustration of an experiment setup for power-handling test of the proposed nonreciprocal bandpass filters.

### DETAILED DESCRIPTION

A nonreciprocal tunable bandpass filter having wideband isolation is described. The bandpass filter is a frequency selective filter circuit used in electronic systems to separate a signal at one particular frequency, or a range of signals that lie within a certain “band” of frequencies from signals at all other frequencies. This band or range of frequencies is set between two cut-off or corner frequency points labeled the “lower frequency” (fL) and the “higher frequency” (fH) while attenuating any signals outside of these two points. A nonreciprocal bandpass filter is one that only allows electromagnetic waves (signals) to flow in one direction. In one or more embodiments, the device includes a microstrip transducer and a ferrite body having at least two opposing parallel edges. The ferrite body is disposed on the microstrip transducer such that the parallel edges of the ferrite body are tilted out of alignment with respect to the parallel coupled microstrip lines of the microstrip transducer.

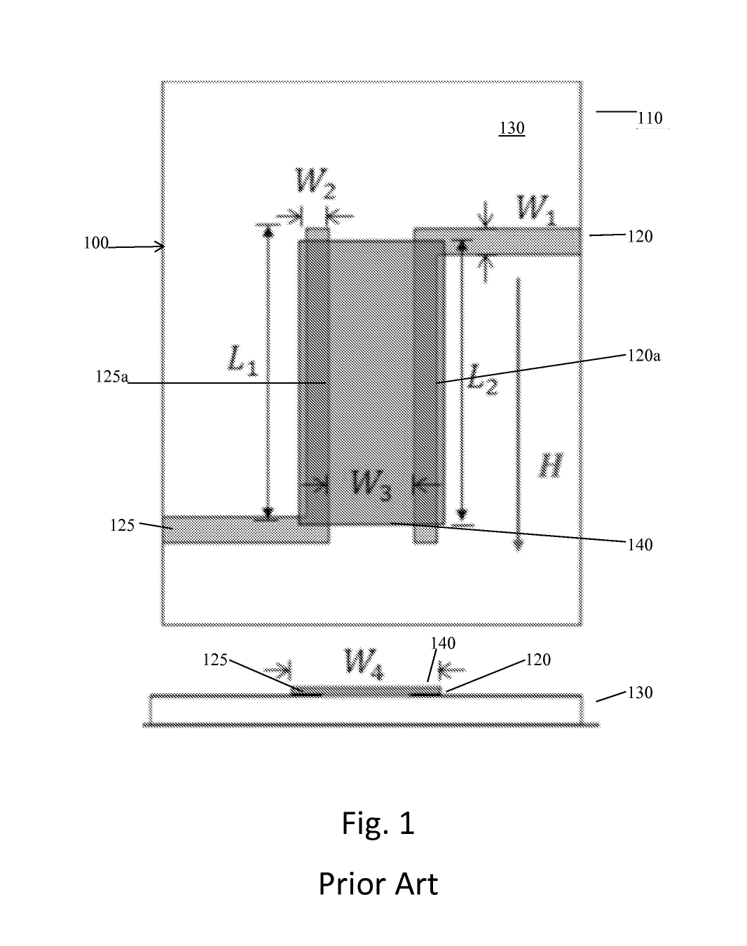

FIG. 1 is a schematic illustration of a conventional tunable bandpass filter 100. The tunable bandpass filter 100 includes a microstrip transducer 110 made up of microstrips 120, 125 having at least regions 120a, 125a that are parallel to one another disposed on a dielectric substrate 130. The microstrips 120 and 125 are coupled to operate as a transducer. A ferrite body 140 is disposed above the microstrip transducer. In this example, W₁=0.37 mm, W₂=0.32 mm, W₃=1.2 mm, W₄=2 mm, L₁=4 mm and L₂=3.6 mm. Current parallel coupled microstrip bandpass filter have a fixed center frequency, around which the selected frequencies “pass”, while others are excluded.

In conventional bandpass filters, the ferrite body 140 is arranged so that the edges of the ferrite body are parallel to the microstrips, as shown in FIG. 1. A d/c current (not shown) can be applied, e.g., using a current carrying wire near the ferrite body or using a winding which encircles the parallel coupled microstrip lines and the ferrite body, to the bandpass filter to produce a magnetic biasing field H (indicated by arrow H) in FIG. 1) within the ferrite. The induced magnetic biasing field H changes the magnetic permeability of the ferrite, and thus the center frequency of the filter may be manipulated due to the resultant change in the velocity of the magnetostatic standing waves (MSW) between the coupled microstrip lines 120 and 125.

Conventional bandpass filters such as illustrated in FIG. 1 are reciprocal bandpass filters, that is, the magnetostatic standing waves are reflected back at the edges of the ferrite body, resulting in a generation of a number of standing waves and splitting of the passband by spurious standing wave modes, as well as finite length modes (discussed in greater detail below). The reciprocal nature of the bandpass filter can result in undesirable signal reflection, which can interfere with operation of the electronic devices into which the bandpass filters are incorporated.

According to one or more embodiments, a nonreciprocal tunable bandpass filter is achieved by positioning the ferrite body at an angle with respect to the longitudinal direction defined by the parallel coupled microstrip lines. In one or more embodiments, θ can range from 15° to 75°, or θ can range from 30° to 60°, or θ can range from 35° to 55°, or θ can be about 45°.

Microstrip lines are known in the art and the materials and circuitry used for their manufacture and use will be readily apparent to one of skill in the art. Exemplary materials for the microstrip lines includes copper; dielectric substrates commonly used in microelectronics can also be employed in the preparation of the microstriplines. The ferrite body or slab can be any of a number of ferrite materials used in the preparation of magnetically tunable bandpass filters. In certain embodiments, the ferrite material can be a low-loss RF/microwave ferrite material with a relatively low ferromagnetic resonance linewidth of <200˜300 Oe at X-band. Suitable ferrite materials include yttrium iron garnet (YIG), spinel ferrites such as Ni-ferrite, NiZn-ferrites, MnZn-ferrites, Li-ferrite, hexaferrites, etc. In one or more embodiments, the ferrite body has a thickness of greater than 10 μm, or a thickness in the range of 75 μm to several millimeters. In one or more embodiments, the ferrite body is about 100 μm in thickness. The ferrite body can be of any dimension (length, width) or aspect ratio. Thus, the ferrite body can be square, rectangular, hexagonal, octagonal, trapezoidal or a parallelapedal, etc.

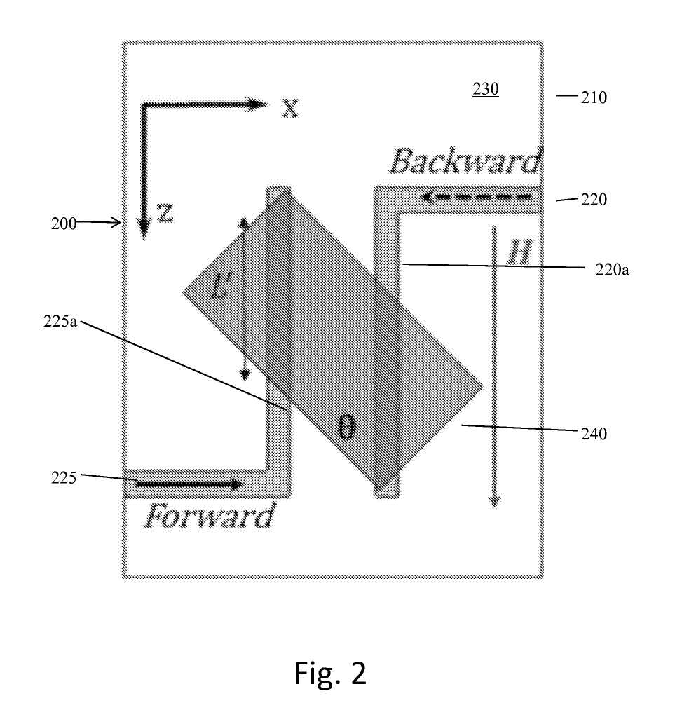

FIG. 2 is a schematic illustration of a nonreciprocal tunable bandpass filter 200 having wideband isolation according to one or more embodiments. The tunable bandpass filter 20 includes a microstrip transducer 210 made up of microstrips 220 and 225 having at least regions 220a and 225a that are parallel to one another disposed on a dielectric substrate 230. As in a conventional bandpass filter, the microstrips 220 and 225 are coupled to operate as a transducer. While shown in FIG. 2 as inverted L-shape transducers, the microstrips lines can be fashioned in any geometry, including straight line, meanderlines, etc. In particular applications, L-shaped microstrip lines have been found to reduce insertion loss (loss of signal power), and coupling at high frequency. To achieve nonreciprocity behavior, a ferrite body 240 is position over the microstrip transducer at an angle respect to the parallel coupled lines of the microstrip transducer. The degree of tilting is shown by angle θ in FIG. 2, and is formed by the intersection of a line 250 defined by one of a pair of opposing parallel edges of the ferrite body and a line 260 defined by an edge of one of the parallel coupled microstrip lines. In this example, W₁=0.37 mm, W₂=0.32 mm, W₃=1.2 mm, W₄=2 mm, L′=2.6 mm and θ=45 degrees.

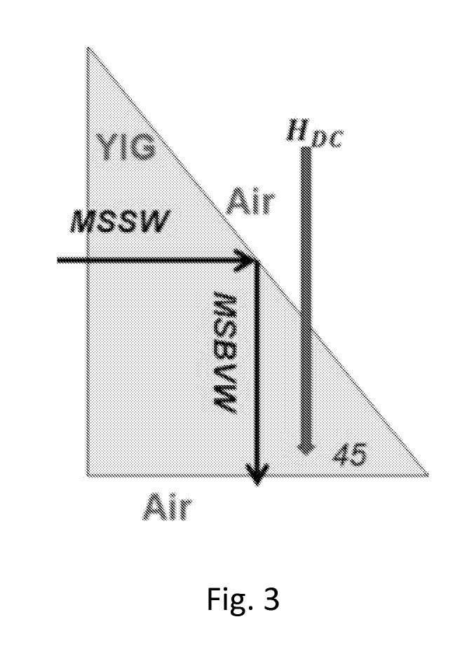

To diminish the splitting modes and achieve the nonreciprocity characteristics, the ferrite slab can be rotated, e.g., by 45°, as is shown in FIG. 3. In this illustration, the bias magnetic field is applied in-plane and perpendicular to the magnetostatic standing wave (MSSW). After the reflection on the 45° edge, the wave will propagate parallel to the bias field, which follows the Magneto-Static Backward Volume Waves (MSBVW) condition. However, because it is operating in the stopband of MSBVW, the reflected wave will decay fast and the energy dissipates, e.g., by heat, along this path. Therefore, the standing-wave resonances will not exist.

In one or more embodiments, θ can range from 15° to 75°, or θ can range from 30° to 60°, or θ can range from 35° to 55°, or θ can be about 45°. A range of angles can be acceptable, in particular, because small variations in ferrite slab properties will occur along its length. Thus, tilt angles that are bracketed around an ideal 45 degree tilt are suitable and can provide a population of Magneto-Static Backward Volume Waves (MSBVW) that will propagate in the direction of the bias field.

In operation, a d/c current can be applied, e.g., using a current carrying wire near the ferrite body or using a winding which encircles the parallel coupled microstrip lines and the ferrite body, to the bandpass filter to produce a magnetic biasing field H (indicated by arrow H) in FIG. 2) within the ferrite. The induced magnetic biasing field H changes the magnetic permeability of the ferrite, and thus the center frequency of the filter may be manipulated due to the resultant change in the velocity of the magnetostatic standing waves between the coupled microstrip lines 220 and 225.

The dissipation of the MSBVW energy provides bandpass filters with exceptional wideband isolation capabilities. The reflected waves are essentially dissipated, meaning that there is no reflected energy in the system. Antennae are typically capable of both transmitting and receiving signals. However, a bandpass filter according to one or more embodiments can possess ultra-wide band isolation that permits only transmission or receiving. The antenna operates in essentially a single direction, e.g., either as a transmitter or a receiver. Ultra-wide band isolation of more than 20 dB can be achieved.

In one embodiment, a bandpass filter was designed with a 45° rotated yttrium iron garnet (YIG) slab loaded on an inverted-L-shaped microstrip transducer pair. With external in-plane magnetic fields from 1.1 to 1.9 kOe, the central frequency of the filter was tuned from 5.2 to 7.5 GHz, with an insertion loss of 1.6-3 dB and an ultra-wideband isolation of more than 20 dB, which was attributed to the nonreciprocity characteristics of the magnetostatic surface wave. In addition, the measured result demonstrated power-handling capabilities of over 30 dBm under room temperature.

The design parameters and performance of a two port nonreciprocal MSSW filter are provided. Relevant parameters include geometrical parameters (slab length L and width W, thickness d, rotation angle θ, and overlap length of the transducer L′), magnetic parameters (external bias magnetic field (H₀), ferrite-film saturation magnetization (4πMs), FMR linewidth (ΔH₀), and resonator spin-wave linewidth (ΔHₖ)) and filter performance parameters (nonreciprocity, group delay τ_{g}, and 3-dB bandwidth f_{3 dB}).

### A. Geometrical Parameters

1) Ferrite Slab width W: For the parallel aligned YIG case, the width W will determine the resonance frequency of the standing-wave modes (n=1, 2, 3 . . . ). Moreover, because the separation between the main resonance and the finite length modes (m=1, 2, 3 . . . ) is inversely proportional to W, the interference of width modes with the main resonance can be minimized by choosing the parameter W to be as small as possible. After rotating the YIG film, the standing-wave modes are eliminated, the slab width W will affect the propagation loss rather than the resonant frequency.

2) Slab length L: the parameter L determines the wavelength of the finite-length mode resonances. From the finite-length mode dispersion relation calculations (m=1, 2, 3 . . . ), reducing the value of L will increase the frequency separation between the resonances and result in better rejection of the (1, 2) resonance with respect to the main resonance (1, 1). However, as L decreases, the power-handling capability of this filter will decrease, due to the decrease of volume of the device.

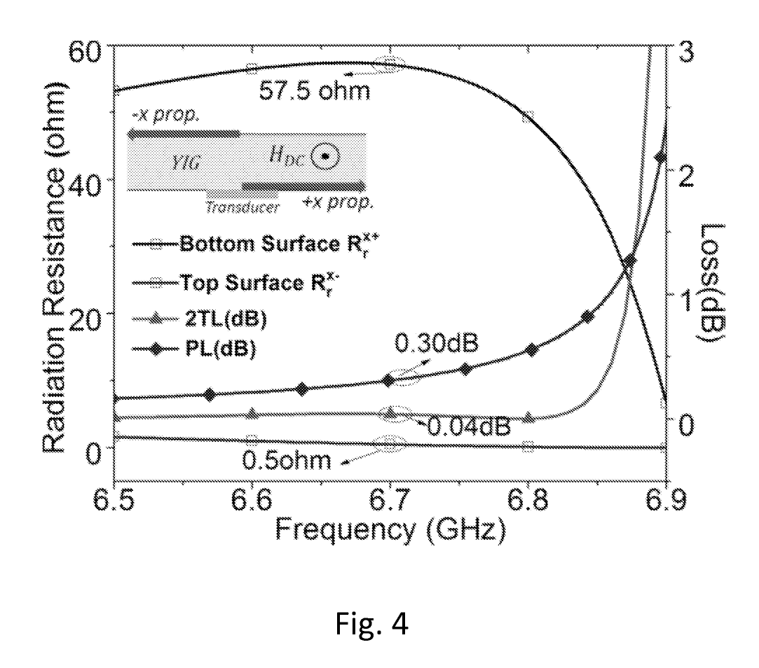

3) Overlap length of the transducer L′: this parameter determines the coupling between transducers and the YIG slab, which affect the input and output reflection coefficients. According to (9) and FIG. 4, the optimal L′ for this case is around 2.6 mm. 4) Rotation angle θ: the rotation of YIG film will cause the nonreciprocity. Rotated by 45 is the optimal design, considering both insertion loss and the nonreciprocity. In fact, the rotation with over 15° can lead to an obvious nonreciprocity. Table I shows the experimentally measured relation between rotation angle and the nonreciprocity.

TABLE I
Experimentally Measured Nonreciprocity in Terms of Rotation Angle θ

| | Resonance | | |
|---|---|---|---|
| Rotation angle | frequency | Insertion loss | Isolation |
| θ (degree) | (GHz) | S21 (dB) | S12 (dB) |
| 0 | 6.57 | 2.4 | 3.2 |
| 15 | 6.58 | 4.1 | 12 |
| 30 | 6.53 | 3.9 | 16.9 |
| 45 | 6.55 | 1.8 | 22 |

This data is tested with YIG film of 500 um thickness
   The isolation (S₁₂) is decreased from 22 to 12 dB, if the rotation angle is changed from 45° to 15°. The insertion loss (S₁₁) is increased from 1.8 to 4.1 dB.

5) Thickness d: a thicker YIG slab leads to wider 3-dB bandwidth. At the same time, since the power compression level of the resonator is proportional to its volume, for a given dimension of L and W, the thicker the YIG is, the better the power-handling ability of the filter will be.

### B. Magnetic Parameters

1) External bias magnetic field (H₀): the orientation of the bias magnetic field determines the FMR frequency of MSSW filters, as well as the operating frequency.

2) YIG-film saturation magnetization (4πMs): the orientation of the bias magnetic field determines the FMR frequency through the permeability tensor.

3) Resonator spin-wave linewidth (Hₖ): this parameter is defined as (Hₖ=f_{3 dB}/γ): f_{3 dB} is the half-power bandwidth of the resonator. The power-handling capability of MSSW filters is proportional to bandwidth.

### C. Filter Performance Parameters

1) Nonreciprocity of the bandpass filters is determined by rotation angle θ. A 45 degree rotation angle leads to minimum insertion loss and maximum isolation.

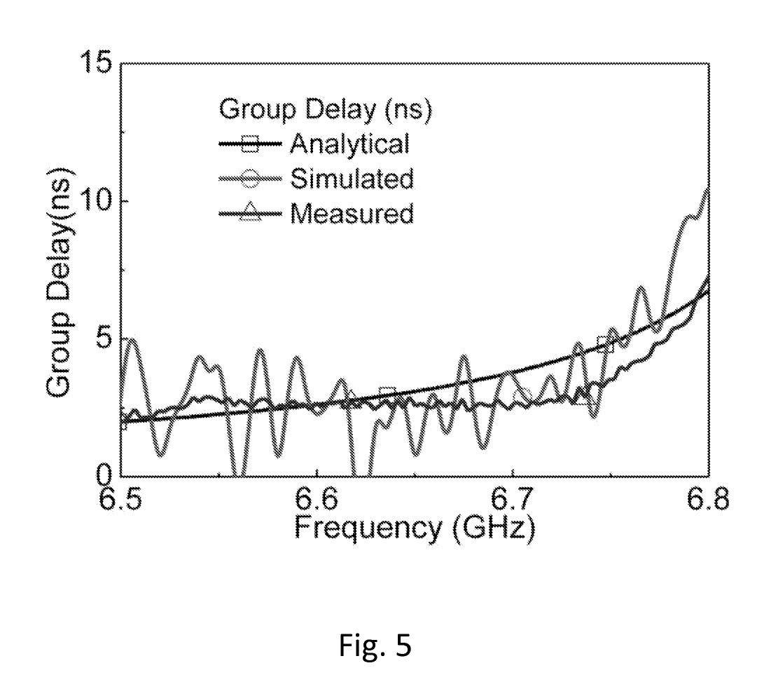

2) Group delay τ_{g}: group delay is the rate of change of phase response with frequency. It can be estimated by in by τ_{g}=ΔΦ/Δω in both HFSS simulation and VNA measurement. Also, analytically, group delay can also be derived via the dispersion relation, as τ_{g}=W/v_{g}=W/(dk/dw), where W is the length along the propagation path. The group delay of the nonreciprocal filter was analyzed with rotated aligned YIG thicknesses d=108 μm, under bias magnetic field 1.6 kOe. From FIG. 5, one sees a good agreement among analytical, simulated, and measured results. A flat group delay around 2.5 ns can be observed from 6.55 to 6.75 GHz, which is roughly inside the 3-dB bandwidth of the passband. The increase of group delay at higher frequency is attributed to the upper cutoff edge of the passband.

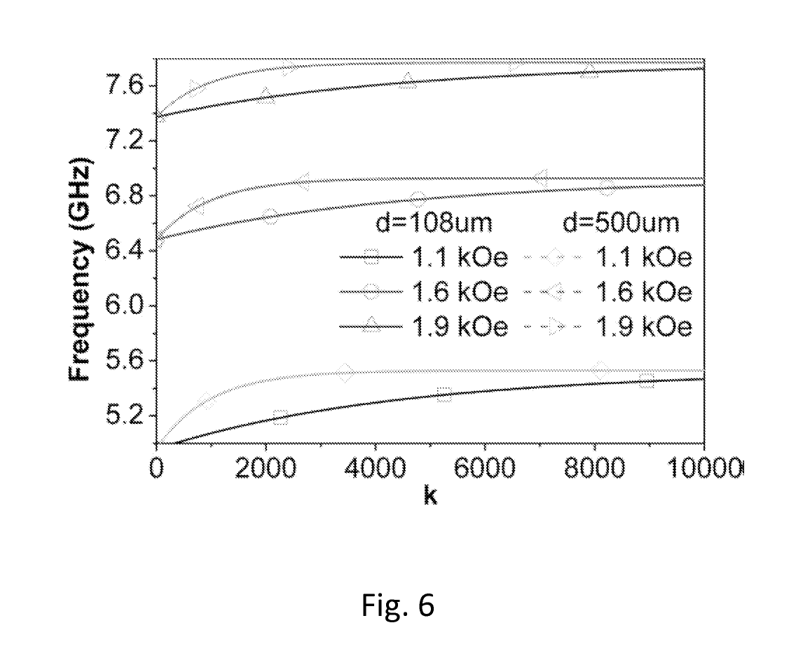

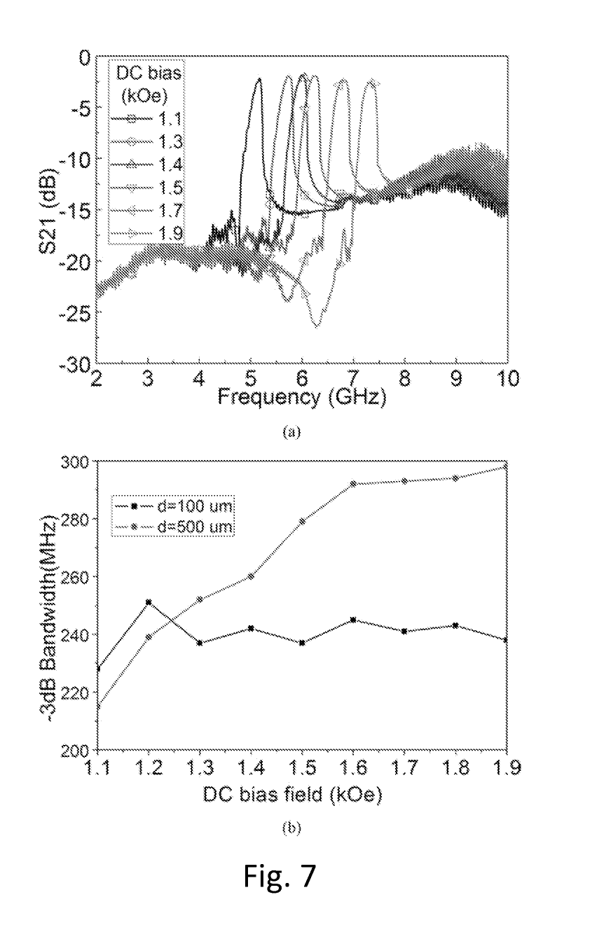

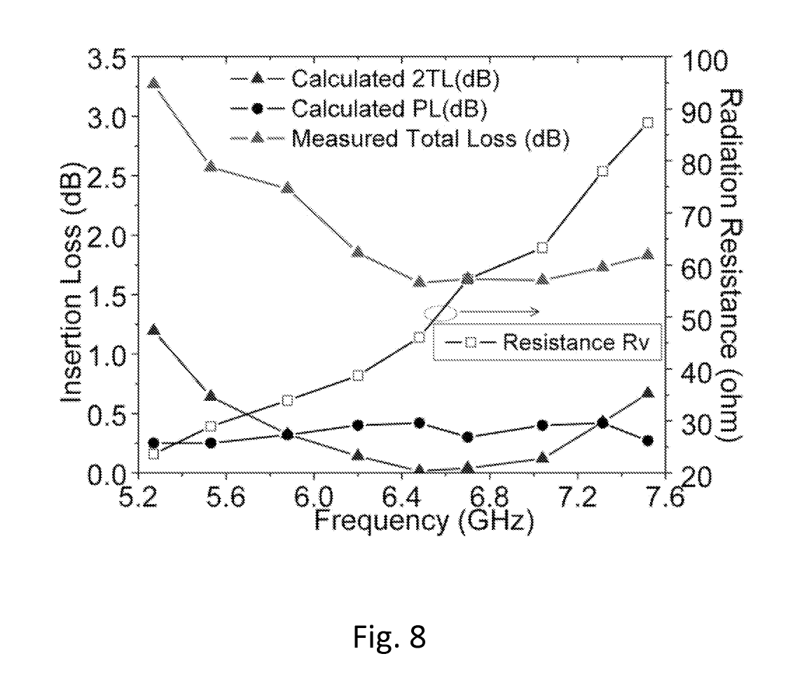

3) Bandwidth: the 3-dB bandwidth of the bandpass filter can attribute to both propagation losses (PL) and transduction losses (TL). FIG. 6 shows the dispersion relation of the MSSW propagation in a YIG slab with thicknesses d=108 and 500 μm, under different bias magnetic fields from 1.1 to 1.9 kOe. Thicker YIG slab leads to wider propagation band for MSSW. The passband has a good agreement with FIG. 7B, where 220-MHz bandwidth is observed for 108 μm; while 300 MHz bandwidth is observed for 500 μm. However, the decrease in bandwidth with low bias field (1.1 to 1.4 kOe) might attribute to the increase of transduction loss. The radiation resistance is less than 25 at 1.1 kOe, as shown in FIG. 8. The loss due to the weak coupling limits bandwidth.

Aspects of the invention is illustrated in the analysis that follows, which is presented for the purpose of analysis only and is not intended to be limiting of the invention. From these parameter analyses, one can select the desired specification for filter designs.

### D. MSW in Tangentially Magnetized Ferrite

MSW can be excited in a YIG slab loaded on an inverted-L shaped microstrip transducer pair as shown in FIGS. 1 and 2. The saturation magnetization (4πMS) of the single crystal YIG slab is about 1750 Gauss, and the ferromagnetic resonance (FMR) linewidth is less than 1 Oe at C-band. Suppose the external bias magnetic field is along the z-axis, the permeability of a single-crystal YIG can be approximated as a frequency-dependent tensor as

$$μ = {μ}_{0} [ \begin{matrix}1 + 𝒳 & i κ & 0 \\ - i κ & 1 + 𝒳 & 0 \\ 0 & 0 & 1\end{matrix} ] \\ χ = \frac{{ω}_{0} {ω}_{m}}{{ω}_{0}^{2} - {ω}^{2}} \\ κ = \frac{{ωω}_{m}}{{ω}_{0}^{2} - {ω}^{2}} \qquad ( 1 )$$

where ωm=−γ4πMₛ, ω₀=−γH₀ is the dc bias field, and w is the angular frequency.

With the magnetostatic approximation, the wave propagation in an infinite YIG slab follows the Walker's equation

(1+χ)(kₓ²+k_{y}²)+k_{z}²=0, (2)

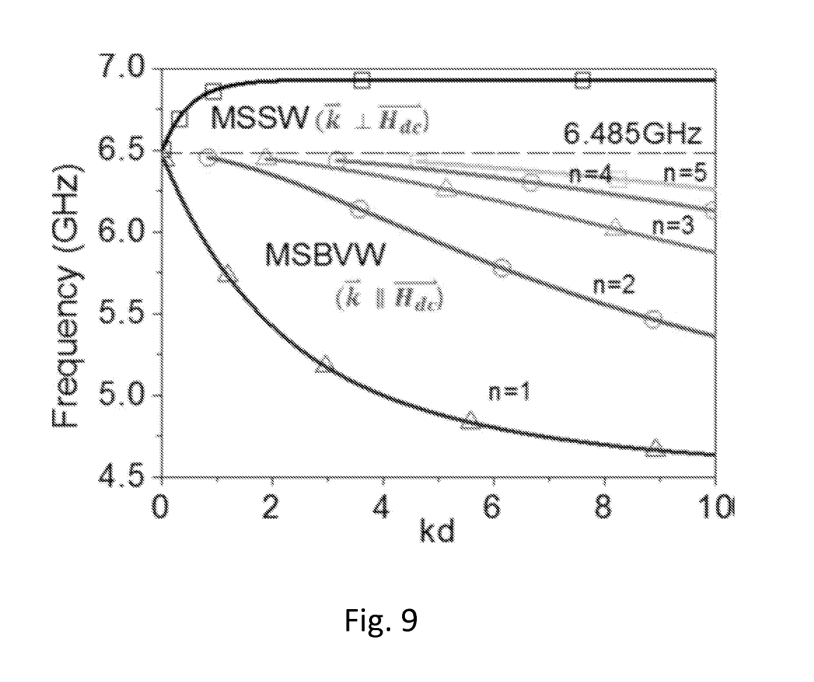

Supposing that the YIG slab was infinite size and ignoring in-plane boundary conditions, the dispersion relation of MSW was calculated and plotted as shown in FIG. 9. Under the bias condition \vec{k}⊥\vec{H_{dc}}, MSSW will be excited at the surface of the YIG slab. More specifically, MSSW with a \vec{kₓ₊} wave propagates on the bottom surface while a \vec{kₓ₋} wave propagates on the top surface. Magnetic potential has a maximum at the surfaces and decays inside the slab and only one mode exists in the ferrite, given as

$${e}^{- 2 kd} = \frac{{( 𝒳 + 2 )}^{2} - {κ}^{2}}{{𝒳}^{2} - {κ}^{2}} \qquad ( 3 )$$

where k is the wave number along the x-axis and d is the thickness of the slab.

Under the bias condition \vec{k}∥\vec{H_{dc}}, magnetostatic back volume wave (MSBVW) will be excited inside the YIG slab. The magnetic potential has a sinusoidal distribution. The back volume wave consists of multimodes with the same cutoff frequencies given by

$$tan ( \frac{{k}_{y} d}{2 \sqrt{- ( 1 + 𝒳 )}} - \frac{( n - 1 ) π}{2} ) = \sqrt{- ( 1 + 𝒳 )} , n = 1 , 2 , 3 … \qquad ( 4 )$$

For practical filter designs, the MSBVW will suffer from ripples due to the multiresonance modes, while MSSW usually has a better resolution due to its single resonance.

E. Nonreciprocity in Ferrite Slab with Finite Size

When the YIG slab is placed parallel to the transducers and the bias magnetic field, \vec{H_{dc}}, is as shown in FIG. 1, the excited MSSW is reflected at the edges of YIG slab, bouncing back and forward. A set of discrete standing-wave modes will be formed when the wave number meets.

(kₓ₊+kₓ₋)W=2πn, n=1,2,3 . . . (5)

where k₊ and k₋ are the wave numbers for forward and backward propagation in the YIG slab, respectively, and is the distance between the two edges of the YIG slab. In addition, the finite length of the films generates additional modes

$${k}_{z} = \frac{π m}{L} , m = 1 , 2 , 3 … \qquad ( 6 )$$

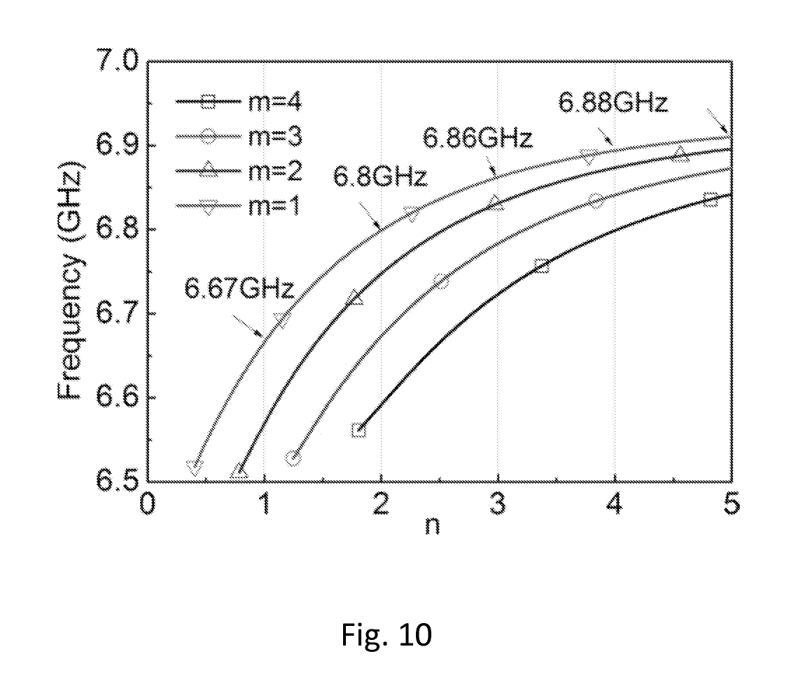

The dispersion relation of MSSW propagating in a finite YIG slab can be expressed as

$${e}^{2 kd} = \frac{𝒳 M - κ k - N}{𝒳 M + κ k + N} \cdot \frac{𝒳 M + κ k - N tan h ( Nt )}{𝒳 M - κ k + N tan h ( Nt )} \\ {M}^{2} = \frac{{( \frac{m π}{L} )}^{2}}{( 1 + 𝒳 )} + {k}_{x}^{2} , for inside YIG slab \\ {N}^{2} = {( \frac{m π}{L} )}^{2} + {k}_{x}^{2} , for outside YIG slab \qquad ( 7 )$$

where t is the thickness of the substrate and k=kₓ indicates the wave number of MSSW. The dispersion relation was plotted in FIG. 10. The input and output transducers can both be coupled at these discrete resonances, which leads to a reciprocal rbandpass filter. On the other hand, the passband will be split by spurious standing-wave modes (n=1, 2, 3 . . . ) and finite length modes (m=1, 2, 3 . . . ). To diminish the splitting modes and achieve the nonreciprocity characteristics, the YIG slab can be rotated, as shown in FIG. 3.

### F. MSW Excitation

Experimentally, it is easy to excite the MSSW by placing a current carrying wire near a YIG slab. Most commonly, microstrip structures with short pins to the ground plane at the end of the strip line are utilized to achieve the excitation. Parallel microstrip have been used as the transducers. A T-shaped microstrip coupling structure and YIG films can also be used to achieve a low-loss C-band tunable bandpass filter. An L-shaped microstrip transducer was observed to enhance the coupling to a minimum insertion loss of 5 dB. In order to improve the insertion loss and isolation and achieve the nonreciprocal behavior at the same time, an inverted-L-shaped transducer can be used, as shown in FIGS. 1 and 2. The transducer is designed on a 0.381-mm-thick Rogers TMM 10i substrate with ∈ᵣ=9.8 and tan δ=0.0022.

Usually, the coupling between the current flowing on the microstrip transducer and the MSSW propagating in the ferrite slab can be modeled as an equivalent lossy transmission line. As the incident wave propagates along the transducer, energy is lost to the MSSW excitation. The radiation resistance per unit length for surface waves traveling in the v (±1) direction (±\hat{x}) can be written as

$${r}_{r}^{v} = \frac{{μ}_{0} ω}{2 kd} [ \frac{1 + 𝒳}{{( 1 + v κ )}^{2} - {( 1 + 𝒳 )}^{2}} ] {\vert \frac{F}{I} \vert}^{2} \qquad ( 8 )$$

where F indicates array factor for the current flowing on microstrip transducer with F=Ie^{-ks}J₀(kw/2), k is the MSSW wave number, w is the width of the transducer, J₀ is the Bessel function of zeroth-order, and s is the vertical spacing between the transducer and YIG/air interface. Here, it is 40 μm for bottom surface of YIG and 148 μm for the top surface.

With an open end, the current distributes nonuniformly across the inverted-L-shaped transducer. The total radiation resistance can then be estimated as

$${R}_{r}^{v} = {\int }_{0}^{L} {r}_{r}^{v} {sin}^{2} ( β y ) d y \qquad ( 9 )$$

where I=I₀ sin(βy) indicates the current on the transducer, β=ω√∈μ₀ considers ∈ᵣ=9.8 of the substrate, 0<y<L is the distance from the open end, and L is the overlap length of YIG slab and transducer.

FIG. 4 shows the calculated radiation resistance under a bias field of 1.6 kOe. The frequency band for MSSW is from 6.5 to 6.9 GHz. Due to the nonreciprocal field displacement, R^{v}_{γ} is quite different between MSSW propagating on the bottom surface (+\hat{x}) and top surface (−\hat{x}). When YIG is rotated by 45°, the overlap length of the transducer is reduced to L′=2.5 mm.

At 6.7 GHz, Rᵥ^{x+}=57.5Ω and Rᵥ^{x-}=0.5Ω. Therefore, the coupling to the top surface can be neglected, while the bottom coupling dominates the MSSW propagation in the YIG slab. If we suppose the feeding transducer is ideally 50Ω at 6.7 GHz, the transduction loss due to impedance mismatch on the bottom surface (forward transmission) can be approximated as 2·TL=0.04 dB, including the transmit and receive transducer. Here,

TL=−10*log(1−((Rᵥ^{x}−50)/(Rᵥ^{x}+50))2).

If the YIG is aligned parallel to the transducer, the reflection from the edges generate surface wave on the top surface, which leads to reciprocal performance and splitting resonance modes. On the other hand, when rotated YIG is applied, the surface wave is limited on the bottom surface due to the nonreflection edges. Nonreciprocity and nonsplitting characteristics can be achieved.

### G. Propagation Loss of MSSW Filters

At a given frequency, the propagation loss of MSSW can be approximated as

$$76.4 Δ H \cdot {τ}_{g} < PL < 76.4 Δ H \sqrt{( 1 + \frac{{ω}_{m}^{2}}{4 {ω}^{2}} )} \cdot {τ}_{g} \qquad ( 10 )$$

where ΔH is the FMR linewidth of YIG in Oe and τ_{g} is the group delay in the YIG slab, defined as dω/dk. The propagation loss under a bias field of 1.6 kOe was calculated as plotted in FIG. 4. PL=0.30 dB was observed for the single-crystal YIG with separation of transducer W=1.2 mm.

### H. Simulated and Measured Results

The proposed transducers were simulated with Ansoft High Frequency Structure Simulator (HFSS) 12.1 and then fabricated and measured via a vector network analyzer (Agilent PNA E8364A). The input power for the measurement is −12 dBm.

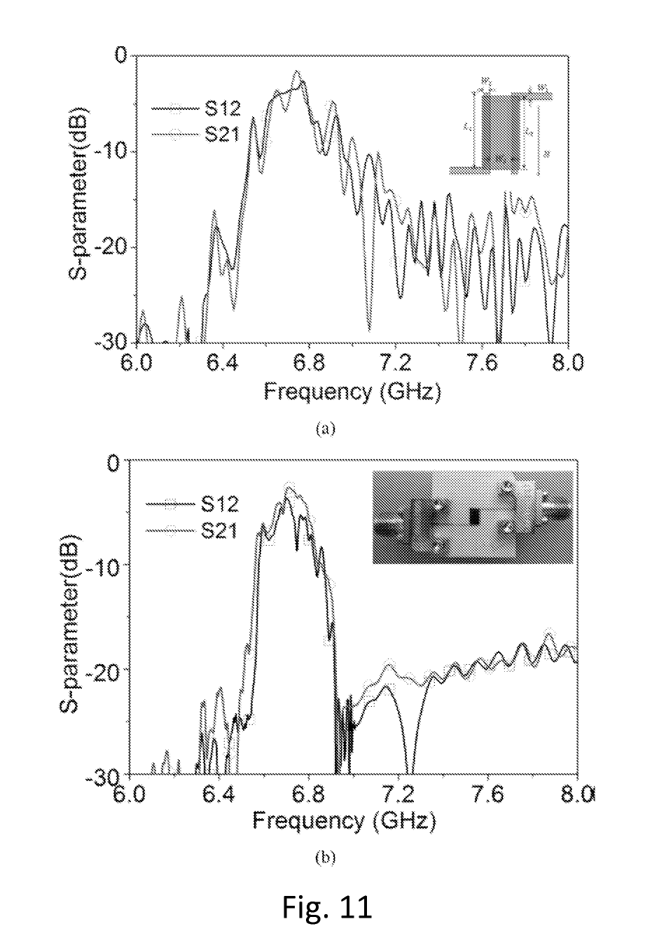

FIG. 11 showed the simulated and measured S-parameters of the bandpass filter with the YIG resonator aligned parallel to the transducers. S₁₂ and S₂₁ responses are reciprocal, with an insertion loss 1.8 dB at the primary resonant frequency of 6.7 GHz, and the 3-dB bandwidth is 170 MHz. However, the discrete resonant modes lead to a passband with many ripples. The indexing of these resonance modes was shown in Table II. The measured results showed higher insertion loss for n>1 than the simulated results did, because of the roughness of the edges from the fabrication process. The reflection from the edges of the YIG slab was reduced in measurement compared with an ideal boundary in simulation.

TABLE II
Indexing of Resonance Modes

| | Resonance | Simulated | Measured |
|---|---|---|---|
| | frequency | Insertion loss | Insertion loss |
| (n, m) | (GHz) | (dB) | (dB) |
| (1, 2) | 6.57 | 6.0 | 6.3 |
| (1, 1) | 6.70 | 1.8 | 2.4 |
| (2, 1) | 6.80 | 4.0 | 5.6 |
| (3, 1) | 6.86 | 5.4 | 8.3 |

n, m indicate high order modes due to reflection and finite lengthₓ, respectively. Here, only the strongest resonances were indexed.

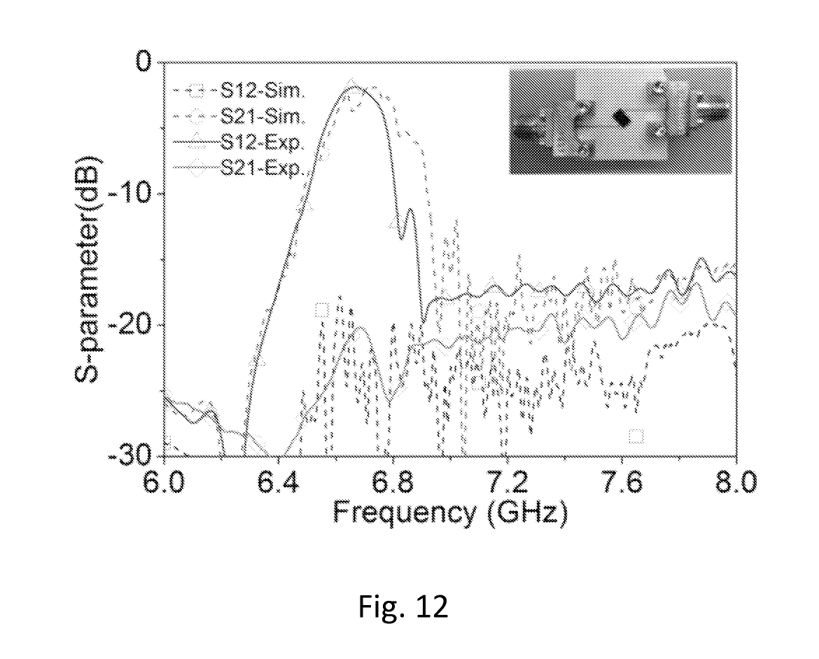

When the YIG resonator was rotated 45° around its center, S₁₂ and S₂₁ showed nonreciprocal transmission behavior. Also, the passband becomes much smoother due to the suppression of the reflections from the edges. The insertion loss of forward transmission is about 1.65 dB at 6.7 GHz, with a bandwidth of 220 MHz (3.2%), while the reverse transmission S₁₂ has isolation greater than 22 dB, as was shown in FIG. 12.

### I. Magnetically Tunned Resonance Frequency

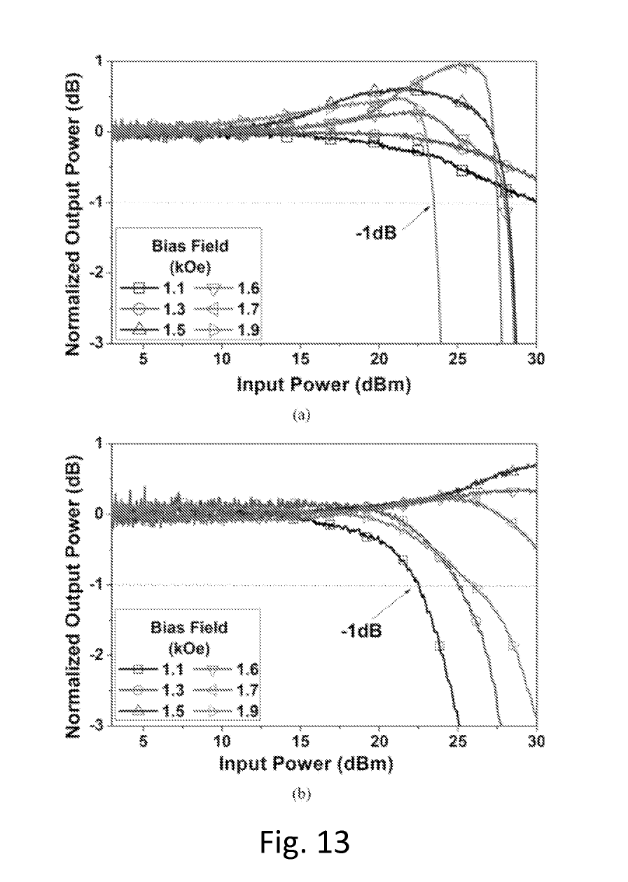

The bandpass filter with 45° rotated YIG resonator was also measured from 5.3 to 7.5 GHz under a dc magnetic field of 1.1-1.9 kOe, as shown in FIG. 13. The results indicated a well-shaped bandpass filter with insertion loss between 1.6-3.0 dB, and bandwidth around 220 MHz at 6.7 GHz. It is notable that this type of design has a relatively high Q of 30 compared with other ferrite tunable bandpass filters. The resonant frequencies follow the Kittel's equation and can be tuned by dc magnetic fields. Furthermore, nonreciprocal performance was observed with isolation over 22 dB between two transmission directions within the filter turning range from 5 to 7.5 GHz. The rejection band is over 15 dB for 2-10 GHz.

S₁₁ and S₂₂ are also plotted in FIGS. 13(c) and 13(d). The reflection coefficients are similar, which are less than −10 dB under most bias fields applied. This indicates that energy dissipates in the YIG film, instead of reflecting back at the ports when fed at port 2.

Another possible reason for higher insertion loss at lower frequencies is the impedance mismatch. At 5.2 GHz (1.1-kOe bias), the return loss is 8.8 dB, and is 7.23 dB while both are over 25 dB at 6.7 GHz. Further optimization on the transducer design may help improve the impedance matching at any specific operating frequencies in a practical application.

In addition, to achieve higher power-handling capability, the bandpass filters with a 500-μm-thick rotated YIG slab was also presented. The measured transmission coefficient was shown in FIG. 7. The 3-dB bandwidth in this case was around 300 MHz under a 1.9-kOe bias field, compared with the bandwidth of 240 MHz when the YIG resonator had 108-μm thickness.

### J. Insertion Loss Analysis

The total insertion loss of the bandpass filter's pass band can be estimated as

IL=2·TL+PL+CL+DL+Other Loss (dB) (11)

where PL and TL can be calculated with (8)-(10), in terms of various bias magnetic fields and central resonant frequencies, as shown in FIG. 8. CL and DL are the conduction loss and dielectric loss of the microstrip transmission line, respectively. CL is estimated to be 0.3034 dB, and DL is 0.08 dB at 6.5 GHz for the transducers fabricated on Rogers TMM 10i substrate with tan δ=0.0022 and total trace length 2.8 mm. Due to the small size of the YIG resonator, PL is around 0.2 to 0.4 dB, with a minimum at 5.2 GHz. Radiation resistance Rᵥ increased from 23.6 to 87.3, when 1.1-1.6-kOe bias fields was applied. The mismatching leads to a transduction loss of 1.2 dB at 5.25 GHz and 0.67 dB at 7.5 GHz, which contributed to the major insertion loss increase, compared with 0.04 dB at 6.5 GHz.

### K. Power-Handling Capability

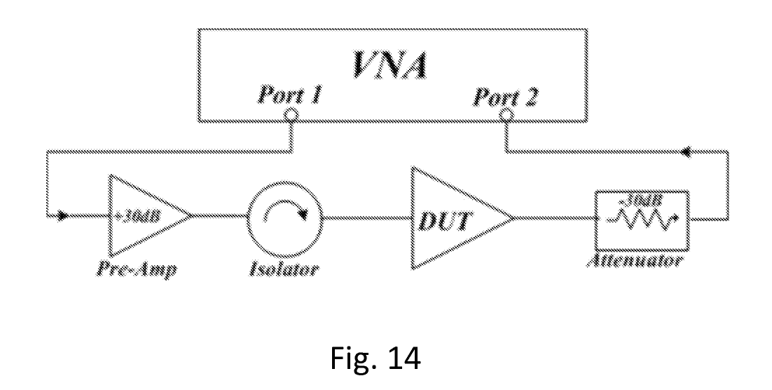

High-power measurements of the bandpass filter were then carried out to investigate the power-handling capability of the nonreciprocal bandpass filters. The schematic of the measurement setup is shown in FIG. 14. The preamplifier provides 30±2 dB gain in the 4-8-GHz range. A sweep of the variable network analyzer (VNA) output power between −27 to 0 dBm gave an input power for the device under test (DUT) in the range of up to 30 dBm.

The nonreciprocal bandpass filters were then tested with varied bias magnetic fields from 1.1 to 1.9 kOe, which tuned the resonance frequency of the bandpass filter from 5.2 to 7.5 GHz. In order to compare the 1-dB compression point IP_{1 dB} under different bias fields and investigate the maximum bandpass filters tuning range with high power handling, the output transmitted powers were normalized with the input power and the insertion loss of the filters at 0-dBm input power. FIGS. 13(a) and 13(b) showed the test results of the bandpass filters with a rotated-YIG slab with two slab thicknesses of d=108 μm and d=500 μm, respectively. For d=108 μm, IP_{1 dB} is 30 dBm for the lower edge of the tuning range (1.1-kOe bias at 5.2 GHz). IP_{1 dB} went up to greater than 30 dBm when the bias field was increased to 1.3 kOe. At the optimal operating region, where the lowest insertion losses were observed (1.5-1.7 kOe); IP_{1 dB} is 27-28 dBm, the IP_{1 dB} was reduced to 23.5 dBm at the upper edge (1.9-kOe bias at 7.5 GHz).

Since the power compression level of resonators is proportional to its volume, for a given YIG dimension of L and W, better power-handling capability of the resonator was expected for the bandpass filter with a 500-μm-thick YIG slab. Table III shows a comparison between these two filters with different resonator thickness. At the optimal tuning region, the IP_{1 dB} are all greater than 30 dBm for the thicker YIG slab.

TABLE III
IP_{1 dB} with Varied Bias Fields

| | |
|---|---|
| d = 108 μm | d = 500 μm |

| | Resonant | | Resonant | |
|---|---|---|---|---|
| Bias Field | Freq. | IP_{1 dB} | Freq. | IP_{1 dB} |
| (kOe) | (GHz) | (dBm) | (GHz) | (dBm) |
| 1.1 | 5.27 | 30 | 5.15 | 22.5 |
| 1.3 | 5.88 | >30 | 5.73 | 25 |
| 1.5 | 6.48 | 28 | 6.24 | >30 |
| 1.6 | 6.70 | 28 | 6.55 | >30 |
| 1.7 | 7.04 | 27 | 6.80 | >30 |
| 1.9 | 7.52 | 23.5 | 7.35 | 26 |

These tests were done with a power sweep at the operating frequency shown in the table.

From FIG. 12 and Table III, one can see that the bandpass filters all have certain frequencies where the high power-handling capability is >30 dBm, 5.15-5.73 GHz for the bandpass filter with 108-μm YIG slab, and 6.24-6.80 GHz for the bandpass filter with the 500-μm YIG slab. At the tuning edge of the lower frequencies, the normalized output power with 1.3-kOe bias dropped slower than that with 1.1 kOe. At the upper tuning edge, the output power with 1.9-kOe cutoff has a smaller input power than that with 1.7 kOe. Therefore, for YIG resonator with both thicknesses, IP_{1 dB} downgraded at both lower and upper tuning edges. It is notable that the normalized output power sometimes went above 0 dB around the −1-dB compression point. This is due to the insertion loss changes compared with those under low power. Nonetheless, the upshift is less than 1 dB and will hardly affect the overall power-handling capability.

There are at least two factors that contribute to these nonlinearity performances: coincidence-limiting effect of ferrite and the premature saturation. The coincidence-limiting effect is related to a subsidiary absorption from coupling between the uniform precession mode and the spin waves with half of the frequency of this mode. The absorption happens below ω_{M}, 4.9 GHz for YIG slabs, where the MSSW devices saturated at a low power level (typically<0 dBm). These effects contribute to the downgrade of IP_{1 dB} at the lower edge of the bandpass filters tuning range. For the MSSW bandpass filters, the closer the operating frequency to, the lower power handling they can achieve. A typical solution for devices intended to operate below 4.9 GHz is to use doped YIG or other ferrites, whose saturation magnetization are smaller than 1750 Gauss.

The premature saturation is related to the instability of susceptibility that arises from nonlinear terms proportional to the exchange and anisotropy energies. The susceptibility first increases and then sharply drops. When the RF power increases to greater than the threshold, the critical field of this threshold power can be estimated as

$${h}_{critical} = 4 Δ {H}_{0} \sqrt{\frac{ϒ Δ {H}_{k}}{{ω}_{0}}} \qquad ( 12 )$$

where ΔH₀ is the FMR linewidth of YIG, ΔHₖ is the spin wave linewidth, defined as ΥΔHₖ=∂_{-3 dB}, where the −3-dB bandwidth of the resonance with γ is the gyromagnetic coefficient, and ω₀ is the FMR frequency related to the external bias field. Therefore, the power-handling capability of MSSW filters is proportional to the bandwidth while inversely proportional to the operating frequency or bias field. This effect contributes to the downgrade of IP_{1 dB} at the upper edge of the tuning range of the bandpass filters. According to (12), the critical field h_{critical} decreased when the FMR frequencies increased, which led to a lower cutoff input power.

The bandwidth for bandpass filters with 108-μm YIG resonator is around 240 MHz while is around 300 MHz for 500-μm YIG at bias field 1.9 kOe, as shown in FIG. 7(b). Therefore, higher h_{critical} is expected for thicker YIG slabs, which means higher power handling. A comparison of FIGS. 13(a) and (b) indicates a good agreement with these analyses. The cutoff input power increased from 23 to 26 dBm for thicker YIG, with 1.9-kOe bias field.

Conventionally, YIG-based bandpass filters are based on its uniform resonance mode, i.e., FMR. Others have reported a MSW filter has 0-dBm power handling with 15-MHz bandwidth at 9 GHz, and that typical MSW filters with 0.2%-0.5% bandwidth can achieve 50-mW power handling (17 dBm). The bandwidth of these filters described herein are around 300 MHz at 6.7 GHz (4.48%), which leads to roughly 10-13 dB increase on IP_{1 dB}. Although the quality factor is lower than other filters based on single resonance modes, the MSSW filter designed based on this concept can achieve a much higher power-handling capability.

Self-heating will be expected during the MSSW propagation and absorption. In real applications, an additional packing technique, e.g., heat sinks, may be applied to dissipate the heat effectively.

A nonreciprocal-band magnetic tunable bandpass filter with a YIG slab has been designed, fabricated, and tested, which is based on an inverted-L-shaped coupling structure loaded with a rotated single-crystal YIG slab. MSSW propagation in the rotated YIG leads to nonreciprocal performance. The tunable resonant frequency of 5.2-7.5 GHz was obtained for the bandpass filter with a magnetic bias field of 1.1-1.9 kOe applied perpendicular to the feed line. At the same time, the bandpass filter acts as a ultra-wideband isolator with more than 20-dB isolation at the passband with insertion loss of 1.6-3 dB. Power-handling capability of over 30 dBm has been demonstrated under room temperature in the filter's tuning range. The demonstrated nonreciprocal magnetically tunable bandpass filters with isolator dual functionality and with high power handling find use in C-band RF front-end and other microwave circuits.

It will be appreciated that while a particular sequence of steps has been shown and described for purposes of explanation, the sequence may be varied in certain respects, or the steps may be combined, while still obtaining the desired configuration. Additionally, modifications to the disclosed embodiment and the invention as claimed are possible and within the scope of this disclosed invention. Further information regarding the invention is found in Wu et al. “Nonreciprocal Tunable Low-Loss Bandpass Filters With Ultra-Wideband Isolation Based on Magnetostatic Surface Wave”, IEEE Trans. Microwave Theory Tech. Vol. 60, No. 12, pp. 3959-3967, December 2012, the content of which are incorporated in its entirety by reference.

What is claimed is:

1. A nonreciprocal tunable bandpass filter, comprising:
a transducer comprising parallel coupled conductive lines; and
a ferrite body having at least two opposing parallel edges, the ferrite body disposed over the transducer such that the parallel edges of the ferrite layer are tilted at a non-zero angle θ with respect to the parallel coupled conductive lines of the microstrip transducer.

2. The nonreciprocal tunable bandpass filter of claim 1, wherein the transducer comprises microstrip lines.

3. The nonreciprocal tunable bandpass filter of claim 1, wherein the transducer comprises an inverted-L shaped microstrip transducer pair.

4. The nonreciprocal tunable bandpass filter of claim 1, wherein the angle θ is in the range of 15°-75°.

5. The nonreciprocal tunable bandpass filter of claim 1, wherein the angle θ is in the range of 30°-60°.

6. The nonreciprocal tunable bandpass filter of claim 1, wherein the angle θ is in the range of 40°-50°.

7. The nonreciprocal tunable bandpass filter of claim 1, wherein the ferrite material comprises a ferrite material with ferromagnetic resonance linewidth of <200˜300 Oe at X-band.

8. The nonreciprocal tunable bandpass filter of claim 1, wherein the ferrite material is selected from yttrium iron garnet (YIG), spinel ferrites such as Ni-ferrite, NiZn-ferrites, MnZn-ferrites, Li-ferrite, hexaferrites.

9. The nonreciprocal tunable bandpass filter of claim 1, wherein the ferrite body comprises yttrium iron garnet (YIG).

10. The nonreciprocal tunable bandpass filter of claim 1, wherein the ferrite body has shape selected from the group consisting of square, rectangular, hexagonal, octagonal, trapezoidal and parallelapedal.

11. The nonreciprocal tunable bandpass filter of claim 1, wherein the bandpass filter has an isolation of greater than 10 dB.

12. The nonreciprocal tunable bandpass filter claim 1, wherein the bandpass filter has an isolation of greater than 15 dB.

13. The nonreciprocal tunable bandpass filter claim 1, wherein the bandpass filter acts as a ultra-wideband isolator with more than 20-dB isolation at the passband with insertion loss of 1.6-3 dB.

14. The nonreciprocal tunable bandpass filter of claim 1, further comprising an electric current source disposed proximate to the ferrite body.

15. A microwave circuit comprising the nonreciprocal tunable bandpass filter of claim 1.

16. A method of filtering a signal, comprising:
providing a bandpass filter according to claim 1;
applying a signal as an input signal to the tunable bandpass filter; and
controlling a bandwidth of the signal as a function of an applied magnetic field.

17. A method of producing a signal comprising:
providing a bandpass filter according to claim 1;
applying a signal as an input signal to the tunable bandpass filter; and
subjecting the bandpass filter to an external electric field to permit the signal to propagate in only one direction.
